(19) United States
(12) Patent Application Publication
(10) Pub. No.: US 2016/0025769 A1
(43) Pub. Date: Jan. 28, 2016

(54) Method for Calibrating an Acceleration Sensor and Acceleration Sensor

(71) Applicant: ROBERT BOSCH GMBH, Stuttgart (DE)

(72) Inventor: Manuel GLUECK, St. Johann (DE)

(21) Appl. No.: 14/379,627

(22) PCT Filed: Feb. 4, 2013
(86) PCT No.: PCT/EP2013/052180

§ 371 Date: Aug. 19, 2014

(30) Foreign Application Priority Data
Feb. 21, 2012 (DE) 10 2012 202 630.4

(51) Int. Cl. G01P 21/00

(52) U.S. Cl. CPC G01P 21/00

(57) ABSTRACT

A method for calibrating an acceleration sensor includes, in a first method step measured values being generated as a function of acceleration forces acting on the acceleration sensor, in a second method step the measured values being analyzed as to whether a spurious acceleration is present, and in a third method step the acceleration sensor being calibrated as a function of a mathematical filter if no spurious acceleration is detected in the second method step. In addition, in the second method step a mathematical hypothesis test is carried out on the measured values for detection of a spurious acceleration.

### BACKGROUND OF THE INVENTION

1. Field of the Invention

The present invention relates to an acceleration sensor and a method for calibrating an acceleration sensor.

2. Description of the Related Art

Sensors, in particular micromechanical sensors such as acceleration, pressure, magnetic-field, or rotation-rate sensors, are used in a wide variety of application sectors. As a result of process variations during sensor production, the sensors must be calibrated to the particular application sector. It is known from the existing art to carry out calibration of an acceleration sensor on the basis of the gravitation vector, which is stable over the long term and temperature-independent. Published German patent application document DE 10 2009 029 216 A1, for example, discloses a method for self-calibration of a three-axis acceleration sensor during operation, in which a check is made in an idle state, using a calibration algorithm, as to whether the absolute value of the measured acceleration corresponds to the absolute value of the acceleration of gravity. The calibration parameters of sensitivity and offset, as well as their respective variance, are estimated here using a shared Kalman filter.

In the known methods, an NIS value (NIS=(y−\hat{y})·S⁻¹·(y−ŷ)) is employed within the Kalman filter in order to detect whether or not a spurious acceleration is present. The parameter S here represents the innovation covariance matrix, y the measured variable (hereinafter also called a “measured value”), and ŷ the estimated variable. A superimposed spurious acceleration having a comparatively large amplitude and dynamics can be detected using this method, chiefly during the initial phase of calibration, but not reliably. If the calibration parameters are still known very inaccurately, miscalibration of the sensor then occurs.

### BRIEF SUMMARY OF THE INVENTION

The method and the acceleration sensor according to the present invention have the advantage with respect to the existing art that in order to determine whether a spurious acceleration is present, a mathematical hypothesis test preceding the calibration method in time is carried out on the measured values, with which test even superimposed spurious accelerations having high dynamics and a large amplitude can be detection. If a spurious acceleration of this kind is detected, the calibration step is not even started or the ascertained measured values are not utilized for calibration.

According to a preferred embodiment, provision is made that in the second method step, a mathematical hypothesis test in the form of a z-test or a t-test is carried out on the measured values. Advantageously, a z-test (also referred to as a Gaussian test) or a t-test makes possible a particularly efficient check as to whether the mean values of the most recently stored measured values match the current measured value.

According to a preferred embodiment, provision is made that in the zero-th method step carried out earlier in time than the first method step, a plurality of further measured values of the past, which were generated as a function of the acceleration forces acting on the acceleration sensor, are stored, in the second method step mean values being calculated from the plurality of stored measured values and checked by way of a null hypothesis as to whether the mean values and the measured values generated in the first method step derive from the same normal distribution. What is proposed here is preferably the null hypothesis that the mean values derive from the same normal distribution with a known variance (U_{S}=U_{K}), or the alternative hypothesis that the mean values are different (U_{S}≠U_{K}).

According to a preferred embodiment, provision is made that as a function of the measured values, a test variable is calculated by dividing the difference between the calculated mean values of the zero-th method step and the measured values from the first method step by a standard deviation, and the test variable being compared with a limit value. The test variable is preferably calculated as follows:

$$z = \frac{{\underline{U}}_{S} - {\underline{U}}_{k} - \underline{D}}{\sqrt{\frac{{\underline{σ}}_{2}^{2}}{{n}_{2}} + \frac{{\underline{σ}}_{1}^{2}}{{n}_{1}}}}$$

According to a preferred embodiment, provision is made that the limit value is calculated from the inverse normal distribution or from the Student's t-distribution, a significance level a being defined:

$$\underline{T} = {N}^{- 1} ( 1 - \frac{α}{2} )$$

According to a preferred embodiment, provision is made that the presence of a spurious acceleration is assumed if the absolute value of the test variables is greater than the limit value. This advantageously creates an unequivocal decision criterion that indicates the presence of a spurious acceleration or the absence of a spurious acceleration. Even spurious accelerations having high dynamics and a large amplitude are thereby detected. The mathematical condition for this is, in particular: |z|>T.

According to a preferred embodiment, provision is made that an interrupt is generated if the presence of a spurious acceleration is assumed, and the calibration of the acceleration sensor being prevented and/or discontinued when the interrupt is detected. This prevents the current measured value from being used to calibrate the acceleration sensor when the current measured value is influenced by a spurious acceleration.

According to a preferred embodiment, provision is made that in the third method step, the acceleration sensor is calibrated using a Kalman filter and in particular a nonlinear Kalman filter, thereby enabling an efficient and precise estimate of the sensitivity and offset of the acceleration sensor during its utilization mode (also referred to as “in-use” calibration). Calibration at the end of the production process line is thus not necessary.

A further subject of the present invention is an acceleration sensor calibrated as recited in the preceding method. The acceleration encompasses in particular a three-axis acceleration sensor. The acceleration sensor preferably encompasses a micromechanical acceleration sensor that is preferably manufactured in a standard semiconductor manufacturing process.

Exemplifying embodiments of the present invention are depicted in the drawings and are explained further in the description that follows.

### BRIEF DESCRIPTION OF THE DRAWINGS

FIG. 1 is a schematic view of a method for calibrating an acceleration sensor in accordance with the existing art.

FIG. 2 is a schematic view of a method for calibrating an acceleration sensor in accordance with an exemplifying embodiment of the present invention.

### DETAILED DESCRIPTION OF THE INVENTION

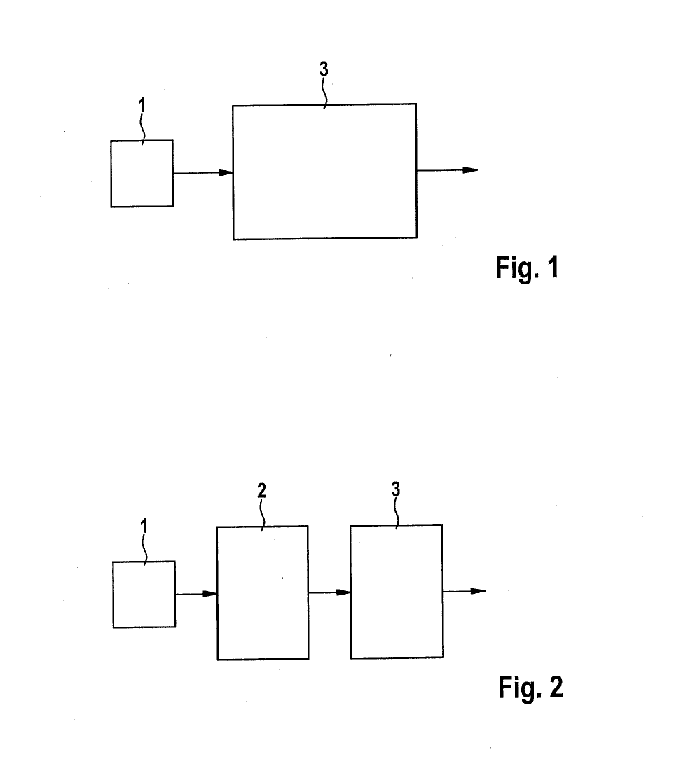

FIG. 1 is a schematic view of a method for calibrating an acceleration sensor in accordance with the existing art. In a first method step, measured values of a three-axis acceleration sensor 1 are generated. The measured values are proportional to accelerations along the three measurement axes of the acceleration sensor. Acceleration sensor 1 encompasses, for example, a substrate and a seismic mass suspended movably along the three measurement axes relative to the substrate. When the acceleration sensor experiences an acceleration, the seismic mass is deflected out of its idle position as a result of inertial forces.

The deflection of the seismic mass is evaluated preferably capacitively, for example using a plate capacitor structure or a finger electrode structure, and is converted into an analog sensor signal. The sensor signal is proportional to the magnitude of the deflection and thus to the applied acceleration. Corresponding measured values can then be derived from the sensor signal.

In a third step 3, the measured values are conveyed to a Kalman filter. When acceleration sensor 1 is in an idle state (also referred to as a “1-g” state) in which only the acceleration of gravity (1 g) is acting on the acceleration sensor, an estimate of the sensitivity and of the offset of acceleration sensor 1 can be made on the basis of the measured values. A procedure of this kind is evident, for example, from the document DE 10 2009 029 216 A1, the disclosure of which is herewith incorporated by reference.

FIG. 2 is a schematic view of a method for calibrating an acceleration sensor 1 in accordance with an exemplifying embodiment of the present invention. As compared with the calibration method described with reference to FIG. 1, the method according to the present invention has an additional step between the identification of the measured values (also referred to as a “first method step”) and the calibration of acceleration sensor 1 (also referred to as “third method step 3”). In the additional step (also referred to as “second method step 2”) a check is made as to whether the measured values generated by acceleration sensor 1 in the first method step are influenced by an impulsive spurious acceleration. The second method step is therefore also referred to hereinafter as “spurious acceleration detection.”

For impulsive spurious acceleration detection, the last n measured values (also referred to as “further measured values”) are stored, in particular in zero-th method steps preceding the first method step in time

$${\underline{U}}_{s} = ( \begin{matrix}{a}_{k - 1 , x} … {a}_{k - n - 1 , x} \\ {a}_{k - 1 , y} … {a}_{k - n - 1 , y} \\ {a}_{k - 1 , z} … {a}_{k - n - 1 , z}\end{matrix} )$$

The spurious acceleration detection sensitivity is adjusted using the parameters n. The larger the parameters n selected, the less spurious acceleration will be permitted in the signal. The statistical z-test is then used to check whether the mean values of the most recently stored acceleration values match the current measured value. For this, the test variable z is calculated:

$$z = \frac{{\underline{U}}_{S} - {\underline{U}}_{k} - \underline{D}}{\sqrt{\frac{{\underline{σ}}_{2}^{2}}{{n}_{2}} + \frac{{\underline{σ}}_{1}^{2}}{{n}_{1}}}}$$

For this, a null hypothesis is proposed, that the mean values derive from the same normal distribution having a known variance:

(U_{S}=U_{K})

as well as the alternative hypothesis that the mean values are different:

(U_{S}≠U_{K}),

The check of the null hypothesis can be carried out using this double z-test. Because a Gaussian distribution of the z value is present, a limit value T for rejection of the null hypothesis can be calculated using the inverse normal distribution and a defined significance level α:

$$\underline{T} = {N}^{- 1} ( 1 - \frac{α}{2} )$$

If the current measured value differs significantly from the measured-value history, the absolute value of the test variables z of the random sample function is greater than the calculated limit value T:

|z|>T

The null hypothesis is therefore rejected, and the current measured value is not conveyed to the calibration algorithm (third method step 3). This method thus makes it possible to detect the presence of an impulsive spurious acceleration regardless of the in-use calibration method utilized. If the impulsive spurious acceleration is detected in second method step 2, in particular an interrupt is generated which prevents conveyance of the current measured value to the calibration algorithm (third method step 3).

1-9. (canceled)

10. A method for calibrating an acceleration sensor (1), in a first method step measured values being generated as a function of acceleration forces acting on the acceleration sensor, in a second method step (2) the measured values being analyzed as to whether a spurious acceleration is present, and in a third method step (3) the acceleration sensor (1) being calibrated as a function of a mathematical filter if no spurious acceleration is detected in the second method step (2), wherein in the second method step (2) a mathematical hypothesis test is carried out on the measured values for detection of a spurious acceleration.

11. The method as recited in claim 1, in the second method step (2) a mathematical hypothesis test in the form of a z-test or a t-test being carried out on the measured values.

12. The method as recited in one of the preceding claims, zero-th method step carried out earlier in time than the first method step, a plurality of further measured values being generated as a function of acceleration forces acting on the acceleration sensor (1), in the second method step (2) mean values being calculated from the plurality of further measured values and checked by way of a null hypothesis as to whether the mean values and the measured values generated in the first method step derive from the same normal distribution.

13. The method as recited in claim 3, as a function of the measured values, a test variable being calculated by dividing the difference between the mean values and the measured values by a standard deviation, and the test variable being compared with a limit value.

14. The method as recited in claim 4, the limit value being calculated from the inverse normal distribution or from the Student's t-distribution.

15. The method as recited in one of claims 4 or 5, the presence of a spurious acceleration being assumed if the absolute value of the test variables is greater than the limit value.

16. The method as recited in claim 6, an interrupt being generated if the presence of a spurious acceleration is assumed, and the calibration of the acceleration sensor (1) being prevented and/or discontinued if the interrupt is detected.

17. The method as recited in one of the preceding claims, in the third method step (3) the acceleration sensor (1) being calibrated using a Kalman filter and in particular a nonlinear Kalman filter.

18. An acceleration sensor (1) calibrated according to a method as recited in one of the preceding claims.
